(19) United States
(12) Patent Application Publication
(10) Pub. No.: US 2019/0371319 A1
(43) Pub. Date: Dec. 5, 2019

(54) METHOD FOR HUMAN-MACHINE INTERACTION, ELECTRONIC DEVICE, AND COMPUTER-READABLE STORAGE MEDIUM

(71) Applicant: BAIDU ONLINE NETWORK TECHNOLOGY (BEIJING) CO., LTD., Beijing (CN)

(72) Inventor: Wenyu WANG, Beijing (CN)

(21) Appl. No.: 16/281,076

(22) Filed: Feb. 20, 2019

(30) Foreign Application Priority Data
Jun. 4, 2018 (CN) 201810564314.2

(51) Int. Cl. G10L 15/22; G10L 15/26; G10L 25/63; G10L 13/04; G06F 3/16

(52) U.S. Cl. CPC G10L 15/22; G10L 15/26; G10L 2015/223; G10L 13/043; G06F 3/167; G10L 25/63

(57) ABSTRACT

Embodiments of the present disclosure provide a method for human-machine interaction, an electronic device, and a computer-readable storage medium. In the method, a word used in a speech instruction from a user is recognized at a cloud side. An emotion contained in the speech instruction and feedback to be provided to the user is determined based on a predetermined mapping between words, emotions and feedback adapted to the emotion, and providing the feedback to the user is enabled.

### CROSS-REFERENCE TO RELATED APPLICATION

This application is based on and claims priority to Chinese Patent Application Serial No. 201810564314.2, filed on Jun. 4, 2018, the entire content of which is incorporated herein by reference.

### FIELD

Embodiments of the present disclosure generally relate to the computer field and to the artificial intelligence field, and more particularly to a method for human-machine interaction, an electronic device, and a computer-readable storage medium.

### BACKGROUND

When an interaction apparatus having a screen (such as a smart speaker with a screen) is in use, some components of the device are not fully utilized. For example, the screen is generally only used as an auxiliary tool for the presentation of speech interactions, and is used to display a variety of information. That is, traditional smart interaction apparatuses generally perform a single speech interaction only, while other components are not involved in the interaction with the user.

### SUMMARY

Embodiments of the present disclosure relates to a method and an apparatus for human-machine interaction, an electronic device and a computer-readable storage medium.

According to a first aspect of the present disclosure, a method for human-machine interaction is provided. The method includes: recognizing, at a cloud side, a word used in a speech instruction from a user; determining an emotion contained in the speech instruction and feedback to be provided to the user based on a predetermined mapping between words, emotions and feedback, wherein the feedback is adapted to the emotion; and enabling providing the feedback to the user.

According to a second aspect of the present disclosure, a method for human-machine interaction is provided. The method includes: sending an audio signal comprising a speech instruction from a user to a cloud side; receiving information from the cloud side, wherein the information indicates feedback to be provided to the user, and the feedback is adapted to an emotion contained in the speech instruction; and providing the feedback to the user.

According to a third aspect of the present disclosure, an apparatus for human-machine interaction is provided. The apparatus includes: a recognizing module, configured to recognize, at a cloud side, a word used in a speech instruction from a user; a determining module, configured to determine an emotion contained in the speech instruction and feedback to be provided to the user based on a predetermined mapping between words, emotions and feedback, wherein the feedback is adapted to the emotion; and a providing module, configured to enable providing the feedback to the user.

According to a fourth aspect of the present disclosure, an apparatus for human-machine interaction is provided. The apparatus includes: a sending module, configured to send an audio signal comprising a speech instruction from a user to a cloud side; a receiving module, configured to receive information from the cloud side, wherein the information indicates feedback to be provided to the user, and the feedback is adapted to an emotion contained in the speech instruction; and a feedback module, configured to provide the feedback to the user.

According to a fifth aspect of the present disclosure, an electronic device is provided. The electronic device includes: one or more processors; and a memory, configured to store one or more programs that, when executed by the one or more processors, cause the one or more processors to perform the method according to the first aspect of the present disclosure.

According to a sixth aspect of the present disclosure, an electronic device is provided. The electronic device includes: one or more processors; and a memory, configured to store one or more programs that, when executed by the one or more processors, cause the one or more processors to perform the method according to the second aspect of the present disclosure.

According to a seventh aspect of the present disclosure, a computer-readable storage medium is provided. The computer-readable storage medium has computer programs stored thereon, when executed by a processor, causing the processor to perform the method according to the first aspect of the present disclosure.

According to an eighth aspect of the present disclosure, a computer-readable storage medium is provided. The computer-readable storage medium has computer programs stored thereon, when executed by a processor, causing the processor to perform the method according to the second aspect of the present disclosure.

It should be understood that the content described in the summary is not intended to limit key or essential features of embodiments of the present disclosure, and is not intended to limit the scope of the disclosure. Additional features of the present disclosure will become apparent in part from the following descriptions

### BRIEF DESCRIPTION OF THE DRAWINGS

The above and additional aspects and advantages of embodiments of the present disclosure will become apparent and more readily appreciated from the following descriptions made with reference to the drawings. In the drawings, several embodiments of the present disclosure are illustrated in an example way instead of a limitation way, in which:

FIG. 1 is a schematic diagram illustrating an example environment in which embodiments of the present disclosure are capable to be implemented;

FIG. 2 is a flow chart of a method for human-machine interaction according to an embodiment of the present disclosure;

FIG. 3 is a flow chart of a method for human-machine interaction according to another embodiment of the present disclosure;

FIG. 4 is a block diagram illustrating an apparatus for human-machine interaction according to an embodiment of the present disclosure;

FIG. 5 is a block diagram illustrating an apparatus for human-machine interaction according to another embodiment of the present disclosure;

FIG. 6 is a schematic diagram illustrating a device capable of implementing embodiments of the present disclosure.

Throughout the drawings, the same or similar reference numerals are used to indicate the same or similar elements.

### DETAILED DESCRIPTION

Principles and spirit of the present disclosure will be described below with reference to several exemplary embodiments illustrated in the accompanying drawings. It is to be understood, the specific embodiments described herein are used to make the skilled in the art to well understand the present disclosure, and are not intended to limit the scope of the disclosure in any ways.

In related art, only a single speech interaction is performed generally when a traditional human-machine interaction device is in use. However, this single interaction does not reflect the “intelligent” advantage of the intelligent human-machine interaction device, so that the human-machine interaction device cannot communicate with the user more humanely, resulting in a bad user experience, and long term use may make the user bored.

In view of the above problems and other potential problems existing in the traditional human-machine interaction device, embodiments of the present disclosure provide a human-machine interaction solution based on user emotions, a main idea of which is to determine an emotion expressed in a speech instruction by a user, feedback that is to be provided to the user and is adapted to the emotion by utilizing a predetermined mapping between words, emotions and feedback, thereby achieving emotional interaction with the user. In some embodiments, the feedback may include a variety of forms, such as a visual form, an auditory form, a touching form, etc., thus providing a more stereoscopic emotional interaction experience to the user.

Embodiments of the present disclosure solve a problem that interaction content of the human-machine interaction device is single and interaction mode is monotonous, intelligence of the human-machine interaction device is improved, so that the human-machine interaction device can perform emotional interaction with the user, thereby improving human-machine interaction with the user.

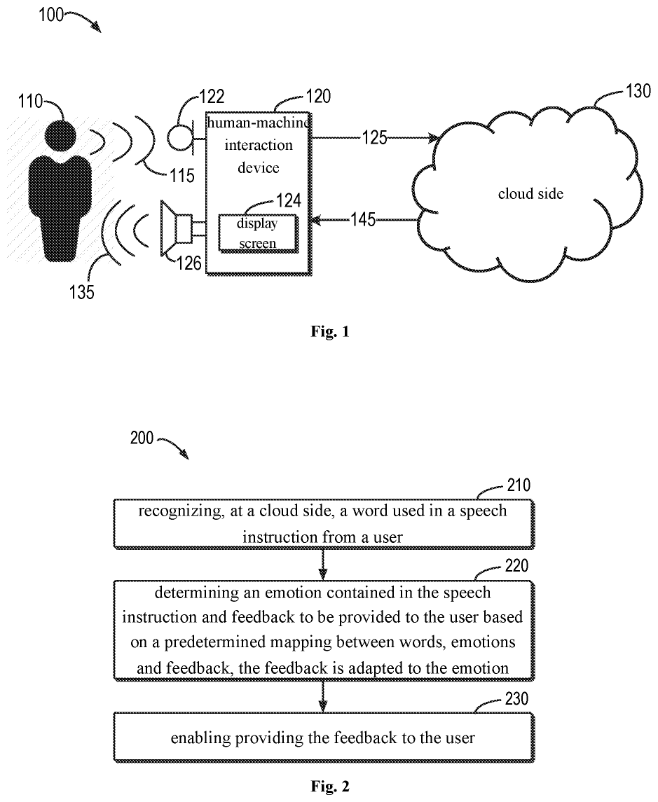

FIG. 1 is a schematic diagram illustrating an example environment 100 in which embodiments of the present disclosure are capable to be implemented. In the environment 100, the user 110 may send a speech instruction 115 to the human-machine interaction device 120 to control operations of the human-machine interaction device 120. For example, in a condition that the human-machine interaction device 120 is a smart speaker, the speech instruction 115 may be “playing a certain song”. However, it should be understood that, embodiments of the human-machine interaction device 120 are not limited to the speaker, and may include any electronic device that the user 110 can control and/or interact with through the speech instruction 115.

The human-machine interaction device 120 may detect or receive the speech instruction 115 of the user through a microphone 122. In some embodiments, the microphone 122 may be implemented as a microphone array, or may be implemented as a single microphone. The human-machine interaction device 120 may perform front-end denoise processing on the speech instruction 115, so as to improve effect of receiving the speech instruction 115.

In some embodiments, the speech instruction 115 from the user 110 may include an emotion. The speech instruction 115 may include a word having emotional color, such as “melancholy”. For example, the speech instruction 115 may be “playing a melancholy song”. The human-machine interaction device 120 may detect or determine the emotion contained in the speech instruction 115 and perform emotional interaction with the user by using the emotion.

In detail, the human-machine interaction device 120 may recognize the word, such as “melancholy”, used in the speech instruction 115. Then the human-machine interaction device 120 determines the emotion of the user 110 and feedback to be provided to the user 110 based on the word and a predetermined mapping between words, emotions and feedback.

For example, the human-machine interaction device 120 may determine the emotion of the user 110 is “gloomy” based on the above mapping, and determine the feedback to be provided to the user 110. For example, the feedback may be a color, an audio, a video, change of temperature, or the like that is adapted to the emotion, so as to make the user 110 have a feeling of being understood during interacting with the human-machine interaction device 120.

To provide the feedback to the user 110, the human-machine interaction device 120 includes a display screen 124. The display screen 124 may be configured to display a particular color to the user to perform emotional interaction with the user 110 in a visual aspect. The human-machine interaction device 120 may further include a loudspeaker 126. The loudspeaker 126 may be configured to play speech 135 to the user 110 to perform emotional interaction with the user 110 in an auditory aspect. In addition, the human-machine interaction device 120 may include a temperature control component (not shown). The temperature control component may adjust a temperature of the human-machine interaction device 120, so that the user 110 can feel temperature change in a touching aspect when touching the human-machine interaction device 120.

In some embodiments, for example, the speech instruction 115 is “playing a melancholy song”. The human-machine interaction device 120 may analyze that the emotion of the user 110 is “melancholy”. Thus, it can be known that the user 110 may be melancholy or in a bad mood. The human-machine interaction device 120 can thus provide various forms of feedback correspondingly. For example, blue is used as a main color and as the background color in the display screen 124 with content such as a lyric of the song displayed.

In other embodiments, the human-machine interaction device 120 may provide feedback of an auditory aspect. For example, speech “When you are in a bad mood, I will accompany you to listen to this song” is played to the user 110 through the loudspeaker 126. Alternatively or additionally, the human-machine interaction device 120 may provide feedback of a visual and auditory aspect. For example, a video whose content is adapted to emotion “melancholy” is played to the user 110 through the display screen 124 and the loudspeaker 126, so as to comfort the user 110 or make mood of the user 110 get better.

In other embodiments, the human-machine interaction device 120 may provide feedback of a touching aspect. For example, the human-machine interaction device 120 may raise temperature of a housing to make the user 110 to feel warm when touching or approaching the human-machine interaction device 120. In some embodiments, the human-machine interaction device 120 may provide above various forms of feedback to the user 110 simultaneously or sequentially in a predetermined order.

In addition, as described above, during recognizing the emotion in the speech instruction 115 of the user 110 and determining the corresponding feedback to be provided by the human-machine interaction device 120, it may be required to utilize processor and memory hardware and/or appropriate software to perform calculations. In some embodiments, such calculations may be performed by a cloud side 130, such that computing load of the human-machine interaction device 120 may be reduced, thus reducing complexity of the human-machine interaction device 120, and reducing cost of the human-machine interaction device 120.

In such embodiments, the human-machine interaction device 120 may send the speech instruction 115 from the user 110 to the cloud side 130 in a form of audio signal 125. After that, the human-machine interaction device 120 may receive information 145 from the cloud side 120. The information 145 may indicate an operation to be performed by the human-machine interaction device 120, such as the feedback to be provided to the user 110. Then, the human-machine interaction device 120 may provide the feedback indicated by the information 145 to the user 110.

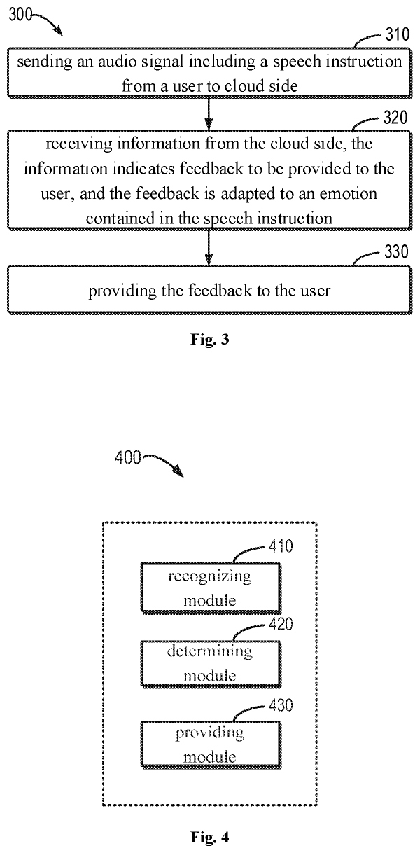

To make the human-machine interaction solution based on emotion provided in embodiments of the present disclosure more readily appreciated, operations related to the solution are described with reference to FIG. 2 and FIG. 3. FIG. 2 is a flow chart of a human-machine interaction method 200 according to an embodiment of the present disclosure. In some embodiments, the method 200 may be implemented by the cloud side 130 in FIG. 1. For ease of discussion, following description will be made with reference to FIG. 2 in combination with FIG. 1.

At block 210, the cloud side 130 recognizes a word used in a speech instruction 115 from a user 110. In some embodiments, to recognize the word in the speech instruction 115, the cloud side 130 may first obtain an audio signal 125 that includes the speech instruction 115. For example, the human-machine interaction device 120 may detect the speech instruction 115 of the user 110, and then generate the audio signal 125 containing the speech instruction 115, and send the audio signal 125 to the cloud side 130. Correspondingly, the cloud side 130 may receive the audio signal 125 from the human-machine interaction device 120, so as to obtain the speech instruction 115 from the audio signal 125.

Then the cloud side 130 converts the speech instruction 115 into text information. For example, the cloud side 130 may perform automatic speech recognition (ASR) processing by utilizing a pre-trained deep learning model, to convert the speech instruction 115 into the text information representing the speech instruction 115. After that, the cloud side 130 extracts the word used in the speech instruction 115 from the text information. In this way, the cloud side 130 may fully use the mature ASR technology to recognize the word used in the speech instruction 115, thus improving accuracy of the recognition.

It should be understood that, using, by the cloud side 130, the ASR model to recognize the word used in the speech instruction 115 is just an example. In other embodiments, the cloud side 130 may use any appropriate technology to recognize the word used in the speech instruction 115.

At block 220, the cloud side 130 determines emotion contained in the speech instruction 115 and feedback to be provided to the user 110 based on a predetermined mapping between words, emotions and feedback. The feedback is adapted to the determined emotion. When determining the emotion of the user 110 and the feedback to be provided to the user 110, the cloud side 130 may obtain the emotion contained in the speech instruction 115 and obtain feedback to be provided to the user 110 by using the predetermined mapping between words, emotions and feedback based on a pre-trained natural language understanding (NLU) model.

It should be understood that, using, by the cloud side 130, the NLU model to obtain the emotion contained in the speech instruction 115 and to obtain the feedback to be provided to the user 110 is just an example. In other embodiments, the cloud side 130 may use any appropriate technology to determine the emotion of the user 110 and the feedback to be provided to the user 110 based on the predetermined mapping between words, emotions and feedback.

To provide more stereoscopic emotional feedback to the user 110, the feedback may include various forms. According to emotion-color theory, light information of colors with different wavelengths acts on human visual organs, the light information is transmitted to the brain through visual nerves, thus a series of color psychological reactions is formed by associating thoughts, memories and experiences of the past. This indicates that there is a certain correspondence between emotions of human and color. Therefore, the human-machine interaction device 120 may perform emotional interaction with the user 110 by visually presenting a color that is appropriate for the emotion.

Similarly, the human-machine interaction device 120 may perform the emotional interaction with the user 110 in an auditory way. For example, when the user 110 is in a bad mood, the human-machine interaction device 120 may play a speech with a comforting meaning on an auditory aspect to alleviate the bad mood of the user 110. Alternatively or additionally, the human-machine interaction device 120 may perform the emotional interaction with the user 110 by combining visual and auditory information. For example, a video whose content is appropriate for the emotion of the user 110 is played to the user 110 through the display screen 124 and the loudspeaker 126.

Alternatively or additionally, the human-machine interaction device 120 may perform the emotional interaction with the user 110 through touch. For example, the human-machine interaction device 120 may raise or lower a temperature of the apparatus to make the user 110 to feel warm or cool. In addition, the human-machine interaction device 120 may provide above various forms of feedback to the user 110 simultaneously or sequentially in a predetermined order.

The feedback to be provided to the user 110 determined by the cloud side 130 may be displaying a predetermined color that is appropriate for the emotion to the user 110, playing a predetermined speech that is appropriate for the emotion to the user 110, playing a predetermined video that is appropriate for the emotion to the user 110, and/or changing the temperature of the human-machine interaction device 120 used by the user 110 in accordance with the emotion, etc.

In this way, an all-round, stereoscopic, and intelligent emotional interaction experience can be provided to the user 110, allowing the user 110 to have a feeling of being understood, thereby generating a stronger bond and stronger companionship with the human-machine interaction device 120, improving user stickiness.

In some embodiments, the predetermined mapping between words, emotions and feedback may be obtained by training based on history information of words, emotions, and feedback. For example, by using the NLU model, a mapping between a positive emotion and words such as “cheerful”, “happy”, “relaxed”, “lively” and the like included in speech instructions used by the use 110 and/or other users in the past may be established, and a mapping between a negative emotion and words such as “melancholy”, “dark”, and the like.

In another aspect, a mapping between an emotion and feedback provided to the user 110 and/or other users in the past may be established. For example, for the visual feedback, such as color, the positive emotion may be mapped to a limited set containing a number of warm colors and bright colors, such as orange, red, and the like. In a similar way, the negative emotion may be mapped to a limited set containing a number of cold colors and dark colors, such as blue, gray, and the like. Thereby, by training with the history information of the words, the emotions, and the feedback, the predetermined mapping between words, emotions and feedback can be continuously expanded and/or updated to recognize more words carrying emotions during subsequent use of the mapping, and the accuracy of the determined emotion is improved.

FIG. 3 is a flow chart of a human-machine interaction method 300 according to another embodiment of the present. In some embodiments, the method 300 may be implemented by the human-machine interaction device 120 illustrated in FIG. 1. For ease of discussion, the method 300 will be described with reference to FIG. 3 in combination with FIG. 1.

At block 310, the human-machine interaction device 120 sends an audio signal 125 including a speech instruction 115 from a user 110 to cloud side 130. At block 320, the human-machine interaction device 120 receives information 145 from the cloud side 130. The information 145 indicates feedback to be provided to the user 110, and the feedback is adapted to an emotion contained in the speech instruction 115. At block 330, the human-machine interaction device 120 provides the feedback to the user 110.

In some embodiments, when providing the feedback to the user 110, the human-machine interaction device 120 may display a predetermined color to the user 110, play a predetermined speech to the user 110, play a predetermined video to the user 110, and change a temperature of the human-machine interaction device 120, or the like.

For example, the human-machine interaction device 120 may set a background color of the display screen 124 to the predetermined color, play a predetermined speech that is appropriate for the emotion to the user 110, play a predetermined video whose content is appropriate for the emotion to the user 110, and/or raise or lower a temperature of the human-machine interaction device 120 to make the user 110 feel warm or cool.

In addition, in an embodiment that feedback provided to the user 110 is the predetermined speech 135, the information 145 may include text information that represents the predetermined speech 135 to be played to the user 110, and the human-machine interaction device 120 may convert the text information into the predetermined speech 135. For example, the conversion may be performed by using Text to Speech (TTS) technology.

It should be understood that, using the TTS technology to convert the text information into the predetermined speech 135 is just an example. In other embodiments, the human-machine interaction device 120 may also use any appropriate technology to generate corresponding speech 135 based on the text information.

In this way, the cloud side 130 can only send the text information occupying relatively little storage space to the human-machine interaction device 120 instead of the audio information occupying relative large storage space, thus saving storage resource and communication resource. In addition, at the human-machine interaction device 120 end, the mature TTS technology can be advantageously used to convert the text information into the predetermined speech provided to the user 110.

FIG. 4 is a block diagram illustrating an apparatus for human-machine interaction 400 according to an embodiment of the present disclosure. In some embodiments, the apparatus 400 may be included in the cloud side 130 illustrated in FIG. 1 or be implemented as the cloud side 130. In other embodiments, the apparatus 400 may also be included in the human-machine interaction device 120 illustrated in FIG. 1 or be implemented as the human-machine interaction device 120.

As illustrated in FIG. 4, the apparatus includes a recognizing module 410, a determining module 420, and a providing module 430. The recognizing module 410 is configured to recognize, at a cloud side, a word used in a speech instruction from a user. The determining module 420 is configured to determine an emotion contained in the speech instruction and feedback to be provided to the user based on a predetermined mapping between words, emotions and feedback. The feedback is adapted to the emotion. The providing module 430 is configured to enable providing the feedback to the user.

In some embodiments, the recognizing module 410 includes an obtaining unit, a converting unit, and an extracting unit. The obtaining unit is configured to obtain an audio signal comprising the speech instruction. The converting unit is configured to convert the speech instruction into text information. The extracting unit is configured to extract the word from the text information.

In some embodiments, the providing module 430 is further configured to perform at least one of: enabling displaying a predetermined color to the user; enabling playing a predetermined speech to the user; enabling playing a predetermined video to the user; and enabling changing a temperature of a device used by the user.

In some embodiments, the predetermined mapping is obtained by training based on history information of the words, the emotions, and the feedback.

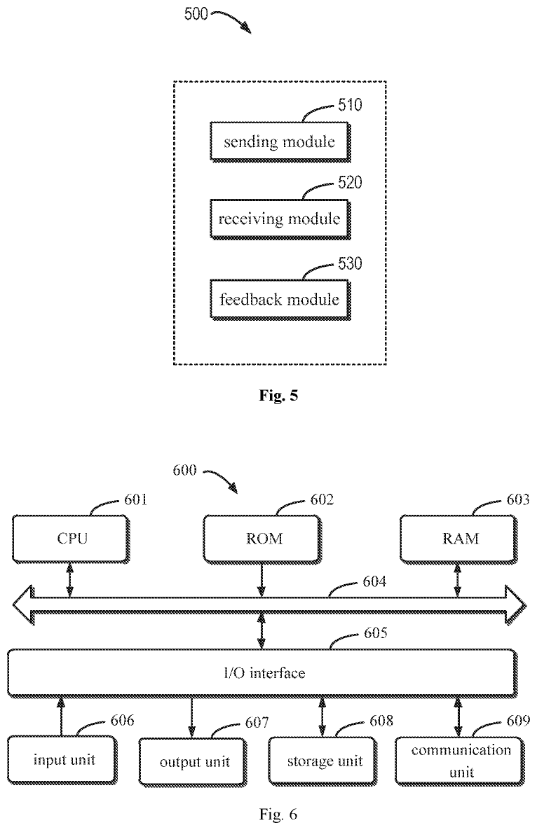

FIG. 5 is a block diagram illustrating an apparatus for human-machine interaction 500 according to another embodiment of the present disclosure. In some embodiments, the apparatus 500 may be included in the human-machine interaction device 120 illustrated in FIG. 1 or be implemented as the human-machine interaction device 120.

As illustrated FIG. 5, the apparatus 500 includes a sending module 510, a receiving module 520, and a feedback module 530. The sending module 510 is configured to send an audio signal including a speech instruction from a user to a cloud side. The receiving module 520 is configured to receive information from the cloud side. The information indicates feedback to be provided to the user, and the feedback is adapted to an emotion contained in the speech instruction. The feedback module 530 is configured to provide the feedback to the user.

In some embodiments, the feedback module 530 is configured to perform at least one of: displaying a predetermined color to the user; playing a predetermined speech to the user; playing a predetermined video to the user; and changing a temperature of the apparatus 500.

In some embodiments, the information received from the cloud side includes text information representing a predetermined speech to be played to the user, and the feedback module 530 includes a converting unit. The converting unit is configured to convert the text information into the predetermined speech.

FIG. 6 is a block diagram illustrating a device 600 that may be used for implementing embodiments of the present disclosure. As illustrated in FIG. 6, the device 600 includes a central processing unit (CPU) 601. The CPU 601 may be configured to execute various appropriate actions and processing according to computer program instructions stored in a read only memory (ROM) 602 or computer program instructions loaded from a storage unit 608 to a random access memory (RAM) 603. In the RAM 603, various programs and data required by operations of the device 600 may be further stored. The CPU 601, the ROM 602 and the RAM 603 are connected to each other via a bus 604. An input/output (I/O) interface 605 is also connected to the bus 604.

Components of the device 600 are connected to the I/O interface 605, including an input unit 606, such as a keyboard, a mouse, etc.; an output unit 607, such as various types of displays, loudspeakers, etc.; a storage unit 608, such as a magnetic disk, a compact disk, etc.; and a communication unit 609, such as a network card, a modem, a wireless communication transceiver, etc. The communication unit 609 allows the device 600 to exchange information/data with other devices through a computer network, such as Internet, and/or various telecommunication networks.

The various procedures and processing described above, such as method 200 or 300, may be performed by the processing unit 601. For example, in some embodiments, the method 200 or 300 can be implemented as a computer software program that is tangibly enclosed in a machine readable medium, such as the storage unit 608. In some embodiments, some or all of the computer programs may be loaded and/or installed onto the device 600 via the ROM 602 and/or the communication unit 609. One or more blocks of the method 200 or 300 described above may be performed when a computer program is loaded into the RAM 603 and executed by the CPU 601.

As used herein, term “comprise” and its equivalents may be understood to be non-exclusive, i.e., “comprising but not limited to”. Term “based on” should be understood to be “based at least in part on”. Term “one embodiment” or “the embodiment” should be understood as “at least one embodiment.” Terms “first,” “second,” and the like may refer to different or identical objects. This specification may also include other explicit and implicit definitions.

As used herein, term “determining” encompasses various actions. For example, “determining” can include operating, computing, processing, exporting, investigating, searching (e.g., searching in a table, database, or another data structure), ascertaining, and the like. Further, “determining” can include receiving (e.g., receiving information), accessing (e.g., accessing data in a memory), and the like. Further, “determining” may include parsing, choosing, selecting, establishing, and the like.

It should be noted that embodiments of the present disclosure may be implemented via hardware, software, or a combination of software and hardware. The hardware can be implemented using dedicated logic; the software can be stored in a memory and executed by a suitable instruction execution system, such as a microprocessor or dedicated design hardware. Those skilled in the art will appreciate that the apparatus and method described above can be implemented using computer-executable instructions and/or embodied in processor control codes. For example, a programmable memory or data carrier such as an optical or electronic signal carrier provide such codes.

In addition, although operations of the method of the present disclosure are described in a particular order in the drawings, it is not required or implied that the operations must be performed in the particular order, or that all of the illustrated operations must be performed to achieve the desired result. Instead, the order of steps depicted in flowcharts can be changed. Additionally or alternatively, some steps may be omitted, multiple steps may be combined into one step, and/or one step may be broken into multiple steps. It should also be noted that features and functions of two or more devices in accordance with the present disclosure may be embodied in one device. Conversely, features and functions of one device described above can be further divided into and embodied by multiple devices.

Although the present disclosure has been described with reference to several specific embodiments, it should be understood that the present disclosure is not limited to the specific embodiments disclosed. The present disclosure is intended to cover various modifications and equivalent arrangements within the spirit and scope of the appended claims.

What is claimed is:

1. A method for human-machine interaction, comprising:
recognizing a word used in a speech instruction from a user;
determining an emotion contained in the speech instruction and feedback to be provided to the user based on a predetermined mapping between words, emotions and feedback, wherein the feedback is adapted to the emotion; and
enabling providing the feedback to the user.

2. The method according to claim 1, wherein recognizing the word used in the speech instruction from the user comprises:
obtaining an audio signal comprising the speech instruction;
converting the speech instruction into text information; and
extracting the word from the text information.

3. The method according to claim 1, wherein enabling providing the feedback to the user comprises at least one of:
enabling displaying a predetermined color to the user;
enabling playing a predetermined speech to the user;
enabling playing a predetermined video to the user; and
enabling changing a temperature of a device used by the user.

4. The method according to claim 1, wherein the predetermined mapping is obtained by training based on history information of the words, the emotions, and the feedback.

5. The method according to claim 1, wherein the method is implemented in a cloud side or a human-machine interaction device.

6. The method according to claim 5, wherein, when the method is implemented in the cloud side, the method further comprises:
receiving an audio signal comprising the speech instruction from the human-machine interaction device; and
enabling providing the feedback to the user comprises:
sending information to the human-machine interaction device, wherein the information indicates the feedback to be provided to the user, such that the human-machine interaction device provides the feedback to the user.

7. The method according to claim 6, wherein the information comprises text information representing a predetermined speech to be played to the user, and providing the feedback to the user comprises:
converting the text information into the predetermined speech.

8. An electronic device, comprising:
one or more processors; and
a memory, configured to store one or more programs that, when executed by the one or more processors, cause the one or more processors to perform a method for human-machine interaction, wherein the method comprises:
recognizing a word used in a speech instruction from a user;
determining an emotion contained in the speech instruction and feedback to be provided to the user based on a predetermined mapping between words, emotions and feedback, wherein the feedback is adapted to the emotion; and
enabling providing the feedback to the user.

9. The electronic device according to claim 8, wherein recognizing the word used in the speech instruction from the user comprises:
obtaining an audio signal comprising the speech instruction;
converting the speech instruction into text information; and
extracting the word from the text information.

10. The electronic device according to claim 8, wherein enabling providing the feedback to the user comprises at least one of:
enabling displaying a predetermined color to the user;
enabling playing a predetermined speech to the user;
enabling playing a predetermined video to the user; and
enabling changing a temperature of a device used by the user.

11. The electronic device according to claim 8, wherein the predetermined mapping is obtained by training based on history information of the words, the emotions, and the feedback.

12. The electronic device according to claim 8, wherein the electronic device is implemented in a cloud side or a human-machine interaction device.

13. The electronic device according to claim 12, wherein, when the electronic device is implemented in the cloud side, the method further comprises:
receiving an audio signal comprising the speech instruction from the human-machine interaction device; and
enabling providing the feedback to the user comprises:
sending information to the human-machine interaction device, wherein the information indicates the feedback to be provided to the user, such that the human-machine interaction device provides the feedback to the user.

14. The electronic device according to claim 13, wherein the information comprises text information representing a predetermined speech to be played to the user, and providing the feedback to the user comprises:
converting the text information into the predetermined speech.

15. A computer-readable storage medium, having computer programs stored thereon, when executed by a processor, causing the processor to perform a method for human-machine interaction, wherein the method comprises:
recognizing a word used in a speech instruction from a user;
determining an emotion contained in the speech instruction and feedback to be provided to the user based on a predetermined mapping between words, emotions and feedback, wherein the feedback is adapted to the emotion; and
enabling providing the feedback to the user.

16. The computer-readable storage medium according to claim 15, wherein recognizing the word used in the speech instruction from the user comprises:
obtaining an audio signal comprising the speech instruction;
converting the speech instruction into text information; and
extracting the word from the text information.

17. The computer-readable storage medium according to claim 15, wherein enabling providing the feedback to the user comprises at least one of:
enabling displaying a predetermined color to the user;
enabling playing a predetermined speech to the user;
enabling playing a predetermined video to the user; and
enabling changing a temperature of a device used by the user.

18. The computer-readable storage medium according to claim 15, wherein the predetermined mapping is obtained by training based on history information of the words, the emotions, and the feedback.

19. The computer-readable storage medium according to claim 15, wherein the electronic device is implemented in a cloud side or a human-machine interaction device.

20. The computer-readable storage medium according to claim 19, wherein, when the electronic device is implemented in the cloud side, the method further comprises:
receiving an audio signal comprising the speech instruction from the human-machine interaction device; and
enabling providing the feedback to the user comprises:
sending information to the human-machine interaction device, wherein the information indicates the feedback to be provided to the user, such that the human-machine interaction device provides the feedback to the user.
